(19) United States
(12) Patent Application Publication
(10) Pub. No.: US 2005/0250474 A1
(43) Pub. Date: Nov. 10, 2005

(54) System and method for controlling idle mode location in a broadband wireless access communication system

(75) Inventors: Seung-Eun Hong, Suwon-si (KR); Young-Sik Ma, Anyang-si (KR); Hyon-Goo Kang, Suwon-si (KR); Chan-Yoon Jeong, Suwon-si (KR); Hyun-Kyung Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Gyeonggi-do (KR)

(21) Appl. No.: 11/125,053

(22) Filed: May 9, 2005

(30) Foreign Application Priority Data
May 7, 2004 (KR) 2004-33256
May 14, 2004 (KR) 2004-34368

(51) Int. Cl. H04M 1/66

(52) U.S. Cl. 455/411; 455/410

(57) ABSTRACT

A method is provided for performing an authentication procedure according to location registration and update for a mobile subscriber station (MSS) in a broadband wireless access (BWA) communication system. The system includes the MSS operating in idle mode to minimize power consumption, paging groups each being formed by a plurality of adjacent cells in which a plurality of MSSs are paged, base stations (BSs) for paging the plurality of MSSs within each paging group, and a server for controlling location registration and authentication for the plurality of MSSs. The server determines whether to approve a request for transition to the idle mode received from the MSS through a BS. If the server approves the request for the transition to the idle mode, it allocates authentication information to the MSS through the BS and registers location of the MSS. When it is determined that the MSS has moved to a different paging group, the MSS sends a location update request including a resulting value computed using the authentication information allocated from the server. The server authenticates the MSS according to the authentication information included in the location update request and registers the changed location of the MSS authenticated successfully.

### PRIORITY

This application claims priority to two applications entitled “SYSTEM AND METHOD FOR CONTROLLING IDLE MODE LOCATION IN A BROADBAND WIRELESS ACCESS COMMUNICATION SYSTEM”, filed in the Korean Intellectual Property Office on May 7, 2004 and May 14, 2004 and assigned Serial Nos. 2004-33256 and 2004-34368, respectively, the contents of which are incorporated herein by reference.

### BACKGROUND OF THE INVENTION

1. Field of the Invention

The present invention relates generally to a broadband wireless access (BWA) communication system, and more particularly to a system and method for controlling location of mobile subscriber station (MSS) with idle mode.

2. Description of the Related Art

A large amount of research is currently being conducted on 4th generation (4G) communication systems, which are the next generation communication systems that provide users with various services based on quality of service (QoS) at a transmission rate of about 100 Mbps. More specifically, a large amount of research focuses on broadband wireless access (BWA) communication systems such as wireless local area network (LAN) systems and wireless metropolitan area network (MAN) systems for the 4G communication systems to support high speed data transfer while ensuring mobility and QoS. Representative BWA communication systems are the Institute of Electrical and Electronics Engineers (IEEE) 802.16a communication system and the IEEE 802.16e communication system.

The IEEE 802.16a and 802.16e communication systems adopt orthogonal frequency division multiplexing/orthogonal frequency division multiple access (OFDM/OFDMA) schemes for supporting a broadband transmission network in a physical channel of the wireless MAN system. The IEEE 802.16a communication system only considers the situation where a subscriber station (SS) is fixed. The IEEE 802.16a communication system does not take SS mobility into account, and considers a single cell structure only. However, the IEEE 802.16e communication system is used to support SS mobility in the IEEE 802.16a communication system. An SS with mobility is referred to as a mobile subscriber station (MSS).

According to the standard of the IEEE 802.16e communication system, the MSS can minimize power consumption because it operates in idle mode when traffic to be transmitted/received is absent for a predetermined time. To operate in the idle mode, the MSS transmits a de-registration request (DREG-REQ) message to a serving base station (BS) currently performing a communication function. Upon receiving the DREG-REQ message, the serving BS can approve the idle mode operation of the MSS by transmitting a DREG command (DREG-CMD) message to the MSS. Tables 1 and 2 describe the format of the DREG-REQ message and the format of the DREG-CMD message, respectively.

TABLE 1

| Syntax | Size |
|---|---|
| DREG-REQ_Message_Format( ) { | |
| Management Message Type | 8 bits |
| De-registration_Request_Code | 8 bits |
| Paging Cycle Request | 16 bits |
| TLV_HMAC Tuple | 176 bits |
| } | |

As shown in Table 1, the ‘Management Message Type’ field in the DREG-REQ message is used to distinguish medium access control (MAC) management messages defined by IEEE 802.16e Specification. The ‘De-registration_Request_Code’ field indicates the purpose of the DREG-REQ message. When a ‘De-registration-Request_Code’ value is 1, it indicates an idle mode operation request for the MSS. And when the ‘De-registration_Request_Code’ value is 1, the ‘Paging Cycle Request’ field indicates the cycle where the MSS should receive paging information from a system. The Type Length Value_Hashed Message Authentication Code Tuple(‘TLV_HMAC Tuple’) field is an information field for authenticating the MSS on the basis of security association (SA) information set between the MSS and the current serving BS.

TABLE 2

| Syntax | Size |
|---|---|
| DREG-CMD_Message_Format( ) { | |
| Management Message Type | 8 bits |
| Action Code | 8 bits |
| TLV_Paging Information | 48 bits |
| TLV_REG-duration | 24 bits |
| TLV_HMAC Tuple | 176 bits |
| } | |

As shown in Table 2, the ‘Management Message Type’ field in the DREG-CMD message is used to distinguish MAC management messages defined by IEEE 802.16e Specification. The ‘Action Code’ field indicates the purpose of the DREG-CMD message. ‘Action Code’ values associated with the idle mode are 0×05, 0×06, and 0×07. When the ‘Action Code’ value is 0×05, it indicates that the serving BS has approved an idle mode request of the MSS. When the ‘Action Code’ value is 0×06, it indicates that the serving BS commands the MSS to re-transmit the DREG-REQ message after the time indicated by the ‘TLV_REG-duration’ field has elapsed. When the ‘Action Code’ value is 0×07, it indicates that the serving BS commands the MSS to wait until the DREG-CMD message is re-transmitted. The ‘TLV_Paging Information’ field includes paging group identifier (PG-ID), PAGING_CYCLE, and PAGING_OFFSET parameters associated with the idle mode operation. The PG-ID parameter is given by a system according to location of the MSS. The PG-ID parameter indicates current location information of the MSS.

The PAGING_CYCLE parameter indicates a paging cycle determined by a system that refers to a paging cycle request from the MSS. The PAGING_OFFSET parameter is used when a time point of paging a specific MSS is determined according to a frame number and the PAGING_CYCLE parameter in the system. The ‘TLV_REQ-duration’ field is used when the ‘Action Code’ value is ‘0×06’, and indicates a time point when the MSS can re-transmit the DREG-REQ message. The ‘TLV_HMAC Tuple’ field is an information field used to authenticate the serving BS on the basis of SA information set between the MSS and the current serving BS.

FIG. 1 roughly illustrates a paging service structure in the conventional IEEE 802.16e communication system.

Referring to FIG. 1, adjacent cells can form a single logical group according to region location. A paging and location management (PLM) server 120 allocates a paging identifier (PG-ID) to each logical paging group formed by a plurality of cells. In FIG. 1, cells of paging groups are identified by PG_ID #1 130a, PG_ID #2 130b, PG_ID #3 130c, and PG_ID #4 130d. It is assumed that BS #1 140a serves MSS #1 150, and MSS #1 150 operates in the idle mode by exchanging DREG-REQ and DREG-CMD messages with BS #1 140a. All BSs associated with PG_ID #1 130a can page MSS #1 150. That is, when MSS #1 150 is located within an area associated with PG-ID #1 130a, it can receive a paging service from the BSs.

MSS #1 150 can move to a cell covered by BS #2 140b within an area associated with PG-ID-#2 130b. In this case, MSS #1 150 performs a network entry procedure with BS #2 140b. If MSS #1 150 in the idle mode moves between different cells of an identical paging group, e.g., cells 110a and 110b, a network entry procedure is unnecessary. However, if MSS #1 150 moves between different paging groups, it transitions from the idle mode to active mode that consumes much power, and then performs the network entry procedure. Accordingly, after performing the transition to the active mode and completing the network entry procedure, MSS #1 150 can re-operate in the idle mode by exchanging the DREG-REQ and DREG-CMD messages with BS #2 140b. Subsequently, while operating in the idle mode, MSS #1 150 can receive the paging service from all BSs within an area associated with PG-ID #2 130b.

The following method is used to determine if an MSS has moved to another paging group different from a previous paging group. When all BSs periodically send a paging advertisement (PAG-ADV) message shown in Table 3, the MSS receives the PAG-ADV message and detects PG-ID information included in the PAG-ADV message. The MSS compares its own PG-ID with the detected PG-ID information. If the two PG-IDs are different, the MSS determines that it has moved to a different paging group. The MSS in the idle mode performs a network entry process or a ranging process according to an ‘Action Code’ value when its own ID information (or an ‘MSS MAC address hash’ field shown in Table 3) is included in the PAG-ADV message. Table 3 describes the format of the PAG-ADV message.

TABLE 3

| Syntax | Size |
|---|---|
| PAG-ADV_Message_Format( ) { | |
| Management Message Type | 8 bits |
| Num_Paging Group IDs | 8 bits |
| For (i=0; i<Num_Paging_Group_IDs; i++) { | |
| Paging Group ID | 8 bits |
| } | |
| For (j=0; j<Num_MACs; j++) { | |
| MSS MAC address hash | 24 bits |
| Action Code | 2 bits |
| Reserved | 6 bits |
| } | |
| } | |

As shown in Table 3, when moving to another paging group different from a previous paging group, the MSS operating in the idle mode performs the network entry process and then re-transitions to the idle mode if the idle mode transition requirement is satisfied according to the above procedure. This case has the following problems.

First, when the paging group is set to a narrow area, the paging group may change often as the MSS moves. Whenever the paging group is changed, the MSS performs a procedure for transition to the idle mode after a network entry process. That is, upon determining that the paging group has been changed in the idle mode, the MSS transitions to the active mode and performs the network entry process. After completely performing the network entry process, the MSS re-performs the procedure for transition to the idle mode. As a result, the power saving effect of the MSS is significantly degraded, and network resources are wasted due to frequent message exchanges.

Second, when the paging group is set to a wide area, the number of paging group changes can be reduced, but many BSs periodically transmit PAG-ADV messages, increasing overhead for each paging group.

Third, it is assumed that notification of MSS location change operating in the idle mode is given through a specific BS. In this case, if a server for managing location update information does not authenticate the MSS giving notification of the location change, the location update information may be wrongly used by an unlawful MSS. In effect, a lawful MSS may be denied access to the network.

### SUMMARY OF THE INVENTION

It is, therefore, an aspect of the present invention to provide a system and method for efficiently controlling location registration for a mobile subscriber station (MSS) in a broadband wireless access (BWA) communication system.

It is another aspect of the present invention to provide a system and method for controlling location authentication for a mobile subscriber station (MSS) when a paging group for the MSS is changed in a broadband wireless access (BWA) communication system.

The above and other aspects of the present invention can be achieved by a method for performing an authentication procedure according to location registration and update for a mobile subscriber station (MSS) in a broadband wireless access (BWA) communication system including the MSS operating in idle mode to minimize power consumption, paging groups each being formed by a plurality of adjacent cells in which a plurality of MSSs are paged, base stations (BSs) for paging the plurality of MSSs within each paging group, and a server for controlling location registration and authentication for the plurality of MSSs. The method includes determining if the server approves a request for transition to the idle mode received from the MSS through a BS; allocating authentication information from the server to the MSS through the BS if the server approves the request for the transition to the idle mode; registering location of the MSS in the server; sending a location update request including a resulting value computed using the authentication information allocated from the server when determining that the MSS has moved to a different paging group; authenticating the MSS in the server according to the authentication information included in the location update request; and registering changed location of the successfully authenticated MSS.

The above and other aspects of the present invention can also be achieved by a method for performing an authentication procedure in a mobile subscriber station (MSS) according to location registration and update in a broadband wireless access (BWA) communication system including the MSS operating in idle mode to minimize power consumption, paging groups each being formed by a plurality of adjacent cells in which a plurality of MSSs are paged, base stations (BSs) for paging the plurality of MSSs within each paging group, and a server for controlling location registration and authentication for the plurality of MSSs. The method includes sending, to a first BS, a request for transition to the idle mode when a requirement for the transition to the idle mode in which traffic is not generated for a predetermined time is satisfied; receiving a response to the request for the transition to the idle mode; storing authentication information included in a positive response and performing the transition to the idle mode when the response is positive; periodically broadcasting paging information after the transition to the idle mode; comparing last received paging information with previously received paging information; determining that a paging group has been changed when paging group identification information included in the last received paging information is different from that included in the previously received paging information; sending a location update request including a resulting value computed using allocated authentication information; and receiving, from a second BS, a response to the location update request.

The above and other aspects of the present invention can also be achieved by a method for performing an authentication procedure in a server according to location registration and update in a broadband wireless access (BWA) communication system including a mobile subscriber station (MSS) operating in idle mode to minimize power consumption, paging groups each being formed by a plurality of adjacent cells in which a plurality of MSSs are paged, base stations (BSs) for paging the plurality of MSSs within each paging group, and the server for controlling location registration and authentication for the plurality of MSSs. The method includes determining if the server approves a request for transition to the idle mode received from the MSS through a first BS; allocating authentication information to the MSS through the first BS and registering location of the MSS if the server approves the request for the transition to the idle mode; receiving a location update request from a second BS when a paging group for the MSS is changed; authenticating the MSS; and sending, to the second BS, a response to the location update request of the MSS according to a result of the authentication.

The above and other aspects of the present invention can also be achieved by a method for performing an authentication procedure according to location change of a mobile subscriber station (MSS) in a broadband wireless access (BWA) communication system including the MSS operating in idle mode, paging groups each being formed by a plurality of adjacent cells in which a plurality of MSSs are paged, base stations (BSs) for paging the plurality of MSSs within each paging group, and a server for controlling location registration and authentication for the plurality of MSSs. The method includes sending a ranging request including authentication information from the MSS to a corresponding BS when the MSS determines that it has moved to the BS of a paging group different from a previous paging group; and receiving, from the BS, a ranging response indicating if authentication is successful, in the MSS.

The above and other aspects of the present invention can be also achieved by a system for performing an authentication procedure according to location registration and update in a broadband wireless access (BWA) communication system including a mobile subscriber station (MSS) operating in idle mode to minimize power consumption, paging groups each being formed by a plurality of adjacent cells in which a plurality of MSSs are paged, base stations (BSs) for paging the plurality of MSSs within each paging group, and a server for controlling location registration and authentication for the plurality of MSSs. The system includes the MSS for sending, to a first BS, a request for transition to the idle mode when a requirement for the transition to the idle mode in which traffic is not generated for a predetermined time is satisfied, receiving a response to the request for the transition to the idle mode, storing authentication information included in a positive response when the response is positive, and performing the transition to the idle mode; and the server for determining whether to approve the request for the transition to the idle mode received from the MSS through the first BS, allocating authentication information to the MSS through the first BS if the request for the transition to the idle mode is approved, and registering location of the MSS.

### BRIEF DESCRIPTION OF THE DRAWINGS

The above and other aspects and advantages of the present invention will be more clearly understood from the following detailed description taken in conjunction with the accompanying drawings, in which:

FIG. 1 roughly illustrates a paging service structure in a conventional Institute of Electrical and Electronics Engineers (IEEE) 802.16e communication system;

FIG. 2 is a ladder diagram illustrating an authentication procedure according to location registration and update for a mobile subscriber station (MSS) in accordance with an embodiment of the present invention;

FIGS. 3A and 3B are flow charts illustrating an authentication procedure performed by an MSS according to location registration and update in accordance with an embodiment of the present invention;

FIG. 4 is a flow chart illustrating a procedure performed by a serving base station (BS) when a request for MSS idle mode is made in accordance with an embodiment of the present invention;

FIG. 5 is a flow chart illustrating a location registration and authentication procedure performed by a BS receiving a location update request in accordance with an embodiment of the present invention; and

FIG. 6 is a flow chart illustrating a location control operation performed by a paging and location management (PLM) server in accordance with an embodiment of the present invention.

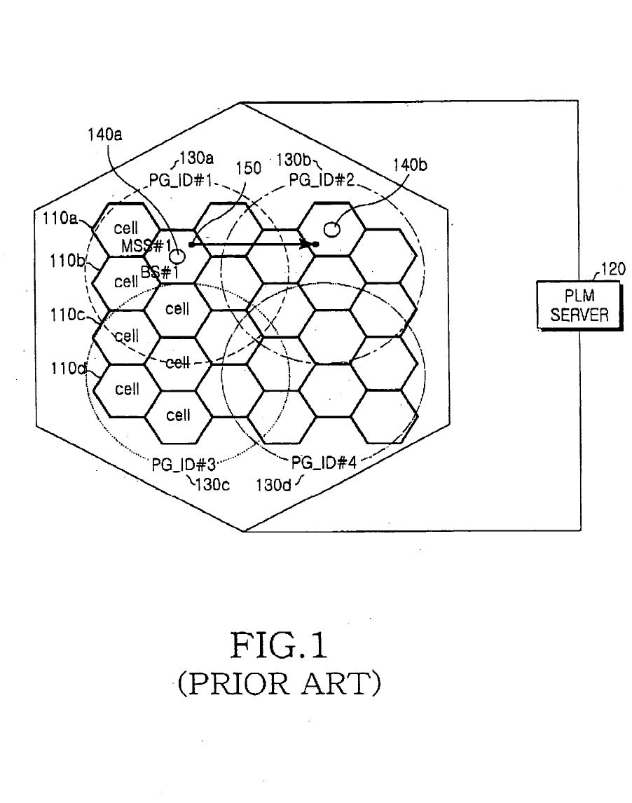

### DETAILED DESCRIPTION OF THE PREFERRED EMBODIMENTS

Preferred embodiments of the present invention will be described in detail herein below with reference to the accompanying drawings. In the following description, a detailed description of known functions and configurations incorporated herein will be omitted for conciseness.

The present invention proposes an authentication method according to efficient location registration and update for a mobile subscriber station (MSS) with idle mode in an Institute of Electrical and Electronics Engineers (IEEE) 802.16e communication system serving as a broadband wireless access (BWA) communication system.

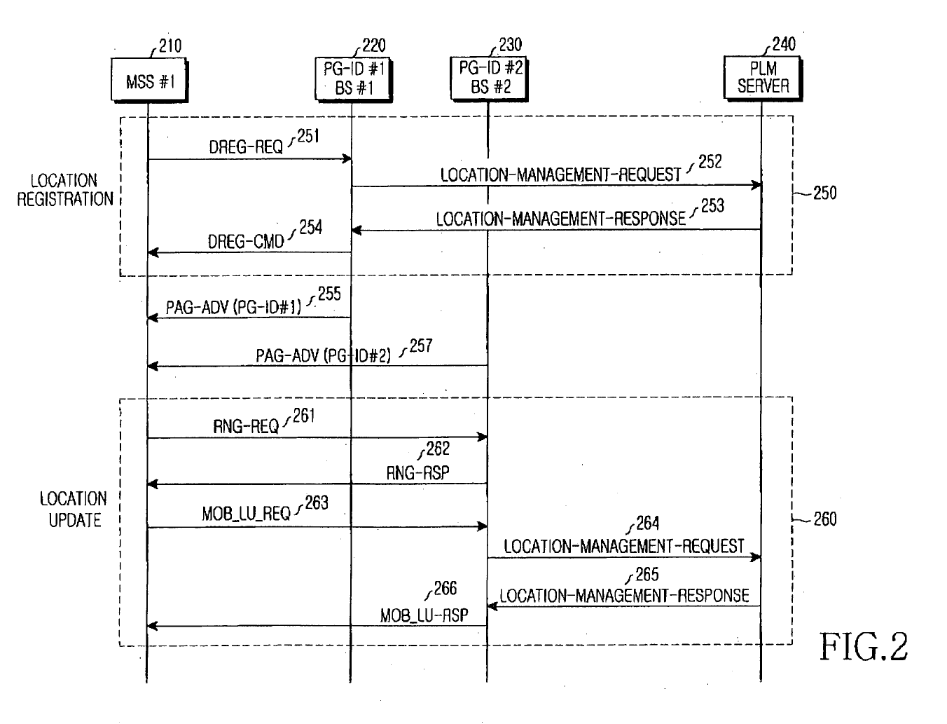

FIG. 2 is a ladder diagram illustrating an authentication procedure according to location registration and update for an MSS in the IEEE 802.16e communication system in accordance with an embodiment of the present invention.

In FIG. 2, MSS #1 210 goes into the idle mode when traffic to be transmitted/received is absent for a predetermined time. The MSS #1 210 sends a de-registration request (“DREG-REQ”) to base station (BS) #1 220 with paging group identifier (PG-ID) #1 serving as a current serving BS (Step 251). Upon receiving the DREG-REQ, BS #1 220 sends a “LOCATION-MANAGEMENT-REQUEST” message to a paging and location management (PLM) server 240 introduced by the present invention (Step 252). The PLM server 240 may be located in the current serving BS or in a different or new network entity. If the PLM server 240 is located in the current serving BS, BS #1 220 does not need to send the “LOCATION-MANAGEMENT-REQUEST” message to the PLM server 240. A case where the PLM server 240 is not located in a serving BS or a different network entity will be described below.

Upon receiving the “LOCATION-MANAGEMENT-REQUEST” message, the PLM server 240 sends a “LOCATION-MANAGEMENT-RESPONSE” message to BS #1 220 (Step 253). When the PLM server 240 is located in the current serving BS, the “LOCATION-MANAGEMENT-RESPONSE” message can be omitted. Upon receiving the “LOCATION-MANAGEMENT-RESPONSE” message, BS #1 220 reads an ‘Action Code’ value from the message. BS #1 220 sends a de-registration command (DREG-CMD) to MSS #1 210 (step 254), and notifies the PLM server 240 of information indicating if the transition to the idle mode of MSS #1 has been approved.

Table 4 describes the format of the LOCATION-MANAGEMENT-REQUEST message.

TABLE 4

| Field | Size | Notes |
|---|---|---|
| Location-management-request_message_format( ) { | | |
| Global Header | 152 bits | |
| For (i=0; i<Num_Records; i++) { | | |
| MSS ID | 48 bits | |
| | | 0x00: Location registration |
| Action Code | 8 bits | 0x01: Location update |
| | | 0x02-FF: Reserved |
| TLV_IDLE AUTH Information | TBD | Valid if action code is 0x00 |
| TLV_Paging Cycle Request | 32 bits | |
| TLV_Previous PG-ID | 24 bits | Valid if action code is 0x01 |
| } | | |
| Security Field | TBD | |
| } | | |

In the LOCATION-MANAGEMENT-REQUEST message shown in Table 4, the ‘Global Header’ field, the ‘Security Field’, and a cyclic redundancy check (CRC) field (not shown) are configured by information fields commonly included in backbone messages according to the conventional IEEE 802.16e standard. The ‘MSS ID’ field is a newly added field to indicate identification information of the MSS requesting an idle mode operation. The ‘Action Code’ field is an information field indicating the action being requested through the LOCATION-MANAGEMENT-REQUEST message. That is, when the PLM server 240 receives the LOCATION-MANAGEMENT-REQUEST message in which the ‘Action Code’ value has been set to ‘0×00’, it can determine that the received message is a message for registering location of an MSS associated with a corresponding MSS ID in a serving BS. Upon receiving the LOCATION-MANAGEMENT-REQUEST message in which the ‘Action Code’ value has been set to 0×00, the PLM server 240 reads the ‘Type Length Value (TLV)_IDLE AUTH Information’ field. The ‘TLV_IDLE AUTH Information’ field indicates security information registered in the serving BS (i.e., BS #1 220) when MSS #1 210 performs the network entry procedure. That is, the security information is security association (SA) information used to establish SA between MSS #1 210 operating in the idle mode and the PLM server 240.

If the PLM server 240 generates a new idle mode authentication key (IDLE_AK), it includes information of the newly generated IDLE_AK in a ‘TLV_IDLE AUTH Information’ field of a “LOCATION-MANAGEMENT-RESPONSE” message, and sends the “LOCATION-MANAGEMENT-RESPONSE” message to the serving BS 220. The serving BS 220 includes a certificate of the MSS in the ‘TLV_IDLE AUTH Information’ field of the “LOCATION-MANAGEMENT-REQUEST” message, and sends the “LOCATION-MANAGEMENT-REQUEST” message. The PLM server 240 can generate IDLE_AK using information included in the certificate. Alternatively, the serving BS 220 may re-use, as IDLE_AK, an AK allocated to the MSS when the MSS enters the network. In this case, the serving BS 220 includes IDLE_AK in the ‘TLV_IDLE AUTH Information’ field of the “LOCATION-MANAGEMENT-REQUEST” message and sends the “LOCATION-MANAGEMENT-REQUEST” message to the PLM server 240. The PLM server 240 uses IDLE_AK when authenticating a message sent from the MSS.

Upon receiving, from BS #1 220, the “LOCATION-MANAGEMENT-REQUEST” message in which the ‘Action Code’ value has been set to 0×01, the PLM server 240 determines that it must update location information of MSS #1 210. The ‘TLV_Paging Cycle Request’ field is an information field indicating a cycle in which MSS #1 210 operating in the idle mode or requesting the idle mode operation desires to receive a PAG-ADV message. The ‘TLV_Previous PG-ID’ field indicates previous PG-ID information of MSS #1 210 when a paging group of MSS #1 210 is changed. The term ‘To Be Discussed (TBD)’ indicates an item to be determined or capable of being determined or corrected according to results of future research.

Table 5 describes the format of the LOCATION-MANAGEMENT-RESPONSE message introduced by the present invention.

TABLE 5

| Field | Size | Notes |
|---|---|---|
| Location-management-response_Message_format( ) { | | |
| Global Header | 152 bits | Message Type = TBD |
| For (i=0; i<Num_Records; i++) { | | |
| MSS ID | 48 bits | |
| | | 0x00: Location registration |
| Action Code | 8 bits | 0x01: Location update |
| | | 0x02-FF: Reserved |
| TLV_IDLE AUTH Information | TBD | |
| TLV_Paging Information | 56 bits | |
| TLV_PLM Server ID | 64 bits | |
| } | | |
| Security Field | TBD | |
| } | | |

As shown in Table 5, the ‘TLV_IDLE AUTH Information’ field is an information field necessary to authenticate MSS #1 210 operating in or to operate in the idle mode. The PLM server 240 uses the ‘TLV_IDLE AUTH Information’ field to issue IDLE_AK for authenticating the MSS. The ‘TLV_Paging Information’ field includes paging group ID, PAGING_CYCLE, and PAGING_OFFSET parameters. The ‘PLM Server ID’ field indicates an ID of the PLM server.

Table 6 describes the format of a new DREG-CMD message obtained by correcting the conventional DREG-CMD message.

TABLE 6

| Syntax | Size |
|---|---|
| DREG-CMD_Message_Format( ) { | |
| Management Message Type | 8 bits |
| Action Code | 8 bits |
| TLV_Paging Information | 48 bits |
| TLV_REG-duration | 24 bits |
| TLV_IDLE AUTH Information | TBD |
| TLV_PLM Server ID | 64 bits |
| TLV_HMAC Tuple | 176 bits |
| } | |

In Table 6, the “Management Message Type’ field, the ‘Action Code’ field, the ‘TLV_Paging Information’ field, the ‘TLV_REG-duration’ field, and the ‘Type Length Value_Hashed Message Authentication Code (TLV_HMAC) Tuple’ field of the new DREG-CMD message are the same as those of the conventional DREG-CMD message. However, the present invention newly adds the ‘TLV_IDLE AUTH Information’ field to the conventional DREG-CMD message. The ‘TLV_IDLE AUTH Information’ field shown in Table 6 is the same as that included in the LOCATION-MANAGEMENT-RESPONSE message received from the PLM server 240. That is, the PLM server 240 uses the ‘TLV_IDLE AUTH Information’ field when IDLE_AK is issued. If the ‘TLV_IDLE AUTH Information’ field is not present, MSS #1 210 re-uses, as IDLE_AK, an AK allocated from BS #1 220 when entering the network. The ‘TLV_PLM Server ID’ field serves as an ID of the PLM server for paging and location management, and is included when MSS #1 210 sends, to an arbitrary BS, a location update request message to be described below. When the PLM server 240 is located in the current serving BS, the ‘TLV_PLM Server ID’ field can be omitted. In this case, MSS #1 210 includes an ID of the current serving BS in the location update request message, and sends the location update request message.

Upon receiving, from BS #1 220, a DREG-CMD message (including Action Code=0×05) indicating that the idle mode operation has been approved, MSS #1 210 transitions to the idle mode. Then, MSS #1 210 is awakened in a cycle negotiated in advance between MSS #1 210 and the PLM server 240, and then receives a PAG-ADV message to determine if it has been paged (Step 255 or 257). The PAG-ADV message is periodically broadcast according to the cycle negotiated in advance between the MSS operating in the idle mode and the PLM server 240. The MSS is awakened in the negotiated cycle, and analyzes the received PAG-ADV message. Through a result of the analysis, the MSS determines if its paging group has been changed, or/and if it has been paged. In this case, it should be noted that MSS #1 210 can move to a different paging group in the idle mode state. It is assumed that MSS #1 210 moves from a paging group having PG-ID #1 to a paging group having PG-ID #2.

MSS #1 210 identifies PG-ID information included in the PAG-ADV message, and then compares the identified PG-ID information with a PG-ID previously given from the PLM server 240. If MSS #1 210 determines that the PG-ID has been changed, it performs a ranging procedure during the conventional network entry procedure with a BS (e.g., BS #2 illustrated in FIG. 2) sending the PAG-ADV message. That is, MSS #1 210 sends a ranging request (“RNG-REQ”) message to BS #2 230 having PG-ID #2 (Step 261), and receives a ranging response (“RNG-RSP”) message from BS #2 230 (Step 262). The RNG-REQ and RNG-RSP messages may include an ‘HMAC Tuple’ field for authenticating the MSS. Subsequently, MSS #1 210 sends, to BS #2 230, a location update request (“MOB_LU-REQ”) message for registering its own location in the PLM server 240 (Step 263). Table 7 describes the format of the MOB_LU-REQ message.

TABLE 7

| Syntax | Size | Notes |
|---|---|---|
| MOB_LU-REQ_Message_format( ) { | | |
| Message Type | 8 bits | |
| Reserved | 6 bits | |
| | | 00 - Location update by new paging Group ID |
| Action Code | 2 bits | 01 - Location update by Timer expiry |
| | | 10˜11 - Reserved |
| TLV_Previous PG ID | 24 bits | |
| TLV_Paging Cycle Request | 40 bits | |
| TLV_PLM Server ID | 64 bits | |
| TLV_HMAC Tuple | 176 bits | Based on SA information between MSS and |
| | | PLM server |
| } | | |

In the format of the MOB_LU-REQ message, the ‘Action Code’ field indicates the action being requested through the MOB_LU-REQ message. When a value of the ‘Action Code’ is ‘00’, the ‘TLV_Previous PG ID’ field indicates a previous PG-ID associated with MSS #1 210 sending the MOB_LU-REQ message. That is, the ‘TLV_Previous PG ID’ field includes ID information of paging group #1 serving as a previous paging group. The ‘TLV_Paging Cycle Request’ field indicates a value of a new paging cycle requested by the MSS. The ‘TLV_PLM Server ID’ field indicates an ID of the PLM server 240 received through the DREG-CMD message, or an ID of the serving BS received through the DREG-CMD message when a ‘PLM Server ID’ field is not present in the DREG-CMD message. The ‘TLV_HMAC Tuple’ field is an authentication information field generated from authentication related information of the DREG-CMD message that MSS #1 210 has received from the PLM server 240 through BS #1 220, or an authentication information field generated from authentication information allocated from the serving BS (BS #1) before transition to the idle mode when authentication information for the idle mode operation is not received from the DREG-CMD message.

Upon receiving the MOB_LU-REQ message, BS #2 230 generates the above-mentioned “LOCATION-MANAGEMENT-REQUEST” message (including Action Code=0×01), and sends the generated message to the PLM server 240 (Step 264). The PLM server 240 reads the ‘HMAC Tuple’ field from the LOCATION-MANAGEMENT-REQUEST message (including Action Code=0×01), and then authenticates MSS #1 210. The PLM server 240 sends a “LOCATION-MANAGEMENT-RESPONSE” message including a result of the authentication to BS #2 230 (Step 265). Upon receiving the LOCATION-MANAGEMENT-RESPONSE message from the PLM server 240, BS #2 230 sends, to MSS #1 210, a location update response (MOB_LU-RSP) message based on the format shown in Table 8 (Step 266). Table 8 describes the MOB_LU-RSP message of the present invention.

TABLE 8

| Syntax | Size | Notes |
|---|---|---|
| MOB_LU-RSP_Message_format( ) { | | |
| Message Type | 8 bits | |
| | | 0x00 - Successful MOB_LU-REQ |
| | | 0x01 - Failed MOB_LU-REQ (The MSS |
| | | should perform network re-entry.) |
| Action Code | 8 bits | 0x02 - The MSS shall not re-transmit the |
| | | MOB_LU-REQ message and shall |
| | | wait for the MOB_LU-RSP message. |
| | | 0x03˜FF - Reserved |
| | | Bits 15:0 - PAGING_CYCLE |
| TLV_Paging Information | 48 bits | Bits 23:16 - PAGING_OFFSET |
| | | Bits 31:14 - Paging Group ID |
| TLV_IDLE AUTH Information | TBD | To be discussed |
| TLV_PLM Server ID | 64 bits | |
| TLV_HMAC Tuple | 176 bits | Based on SA information between MSS and |
| | | PLM server |
| } | | |

The ‘Action Code’ field of the MOB_LU-RSP message shown in Table 8 is associated with the ‘Action Code’ value included in the MOB_LU-REQ message. The ‘Action Code’ field indicates successful authentication according to location change of the MSS when the ‘Action Code’ value is 0×00, and indicates unsuccessful authentication according to location change of the MSS when an ‘Action Code’ value is ‘0×01’. When BS #2 230 sets the ‘Action Code’ value to 0×02, and then sends the MOB_LU-RSP message to MSS #1 210, MSS #1 210 determines that BS #2 230 has received the MOB_LU-REQ message. Subsequently, MSS #1 210 waits until the MOB_LU-RSP message is re-received.

The ‘TLV_IDLE AUTH Information’ field is used when information for authenticating the MSS to operate in the idle mode is changed. The ‘TLV_Paging Information’ field includes Paging Group ID, PAGING_CYCLE, and PAGING_OFFSET parameters associated with the idle mode operation. The ‘PLM Server ID’ field indicates an ID of the PLM server. The ‘TLV_HMAC Tuple’ field includes information generated through SA information set between the MSS and the PLM server.

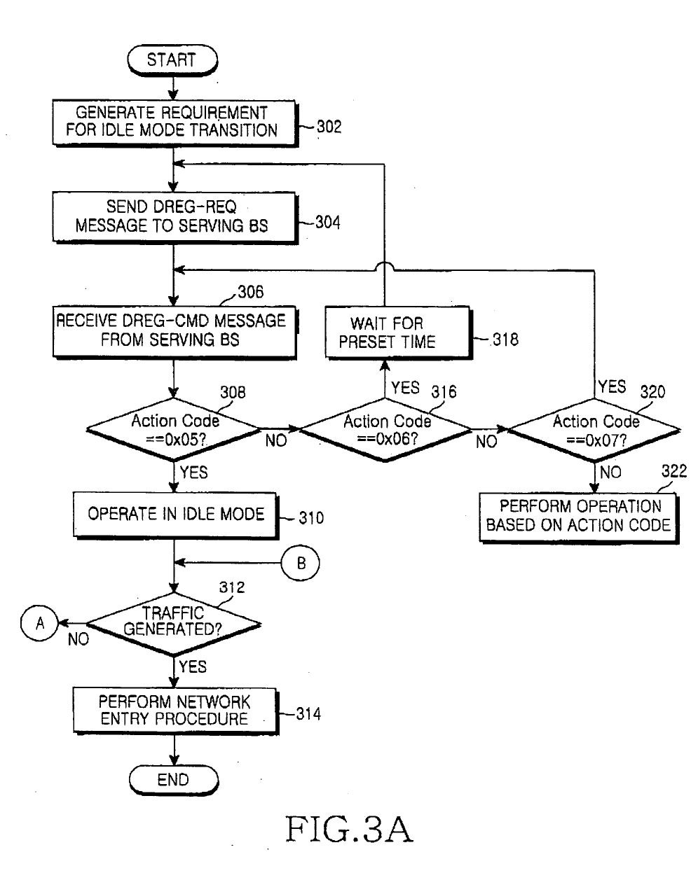

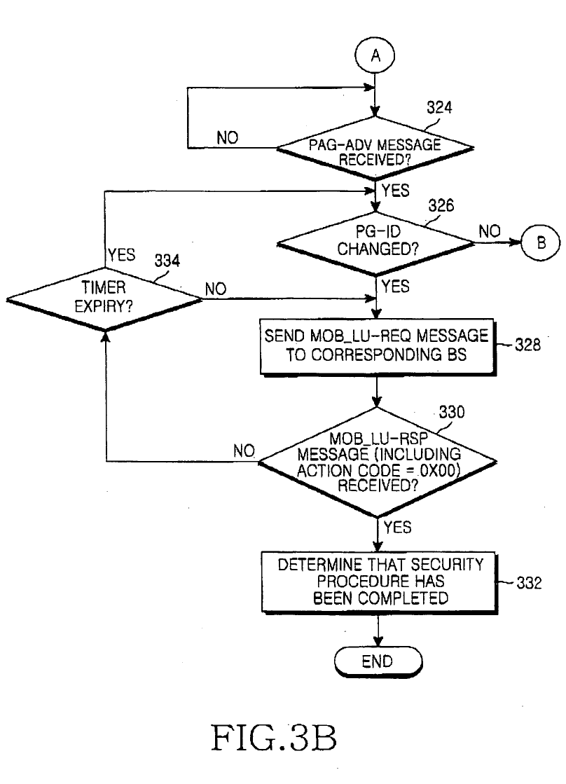

FIGS. 3A and 3B are flow charts illustrating an authentication procedure performed by an MSS according to location registration and update in accordance with an embodiment of the present invention in an IEEE 802.16e communication system.

Referring to FIG. 3A, when a requirement for transition to the idle mode is generated because traffic is absent for a predetermined time in step 302, the MSS proceeds to step 304. The MSS sends, to a serving BS currently performing a communication function, a DREG-REQ message for a request to go into the idle mode in step 304, and then proceeds to step 306. The MSS receives a DREG-CMD message in response to the DREG-REQ message in step 306, and proceeds to step 308. The MSS operates according to an ‘Action Code’ value included in the DREG-CMD message in step 308. When the ‘Action Code’ value is 0×05, the MSS proceeds to step 310. The MSS transitions to the idle mode in step 310, and then proceeds to step 312. The MSS determines if traffic to be transmitted to a BS has been generated in the idle mode in step 312. If traffic has been generated as a result of the determination, the MSS transitions from the idle mode to active mode, and performs a network entry procedure with the BS in step 314.

When the ‘Action Code’ value is 0×06 in step 316, the MSS proceeds to step 318. In step 318, the MSS re-sends the DREG-REQ message to the serving BS after waiting according to waiting time information included in the DREG-CMD message. If the ‘Action Code’ value is 0×07 in step 320, the MSS proceeds to step 306 to wait for the DREG-CMD message from the serving BS. However, if traffic has not been generated in step 312, the MSS proceeds to step 324 of FIG. 3B. When the MSS has received a PAG-ADV message in step 324, it proceeds to step 326. In step 326, the MSS reads a ‘PG-ID’ field of the PAG-ADV message, and compares its own PG-ID with the read PG-ID. When the PG-ID has been changed, the MSS proceeds to step 328. However, when the PG-ID has not been changed, the MSS proceeds to step 312.

In step 328, the MSS sends, to a BS associated with the changed PG-ID, an MOB_LU-REQ message for location update, and proceeds to step 330. A ‘TLV_HMAC Tuple’ field of the MOB_LU-REQ message includes information of a resulting value obtained by performing an authentication algorithm using an AK allocated to the MSS. When the MSS receives an MOB_LU-RSP message (including Action Code=0×00) in response to the MOB_LU-REQ message in step 330, it proceeds to step 332. The MSS determines that the authentication procedure according to location change has been completed in step 332. However, when the MSS has not received an MOB_LU-RSP message for a preset time, it proceeds to step 334 to determine if an MOB_LU-REQ re-setup timer has expired. If the timer has expired, step 326 is performed. However, if the timer has not expired, step 328 is performed.

When the MSS sends, to a corresponding BS, the MOB_LU-REQ message for performing location update in step 328, the corresponding BS can send an MOB_LU-RSP message in which the ‘Action Code’ value has been set to 0×00, 0×01, or 0×02. Accordingly, the MSS performs operation based on the ‘Action Code’ value upon receiving the MOB_LU-RSP message. That is, when the ‘Action code’ value of the MOB_LU-RSP message is 0×01, the MSS determines that the location update has failed, and must perform a network re-entry procedure with a corresponding BS. However, when the ‘Action Code’ value of the MOB_LU-RSP message is 0×02, the MSS waits until the MOB_LU-RSP message is received from the BS.

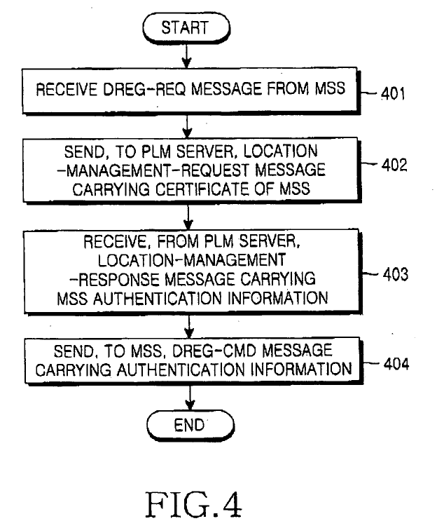

FIG. 4 is a flow chart illustrating the procedure performed by the serving BS when a request for MSS idle mode is made in the IEEE 802.16e communication system in accordance with an embodiment of the present invention.

Referring to FIG. 4, the serving BS receives a DREG-REQ message from the MSS in step 401, and proceeds to step 402. The serving BS sends a LOCATION-MANAGEMENT-REQUEST message including authentication information of the MSS to a PLM server in step 402, and proceeds to step 403. The serving BS receives the LOCATION-MANAGEMENT-REQUEST message including authentication information of the MSS from the PLM server in step 403, and proceeds to step 404. In this case, the MSS may re-use, as an IDLE AK, an AK allocated when performing a network entry procedure with the serving BS, or the PLM server may allocate a new IDLE AK to the MSS. That is, the serving BS sends, to the MSS, authentication information and idle mode information, i.e., a DREG-CMD message including ‘Action Code’ information in step 404.

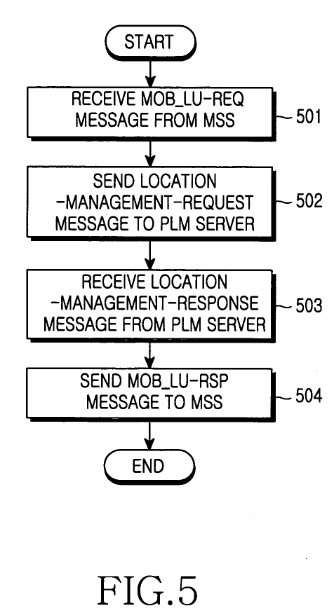

FIG. 5 is a flow chart illustrating a procedure performed by the BS receiving the location update request in accordance with an embodiment of the present invention in an IEEE 802.16e communication system.

Referring to FIG. 5, the BS receives an MOB_LU-REQ message from an MSS in step 501, and proceeds to step 502. In this case, the MSS receives a PAG-ADV message, and determines that a paging group has changed because of a change in location. Accordingly, the MSS sends the MOB_LU-REQ message to a BS of a corresponding paging group. That is, because the MSS has moved to a new paging group, it is re-authenticated by a PLM server. Preferably, the MSS performs only ranging and authentication procedures during a network entry procedure, and does not perform other procedures. In step 502, the BS sends a LOCATION-MANAGEMENT-REQUEST message (including Action Code=0×01) to the PLM server and proceeds to step 503. In step 503, the BS receives, from the PLM server, a LOCATION-MANAGEMENT-RESPONSE message to the LOCATION-MANAGEMENT-REQUEST message, and proceeds to step 504. The LOCATION-MANAGEMENT-RESPONSE message includes information indicating successful authentication as determined by the PLM server. In step 504, the BS sends, to the MSS, an MOB_LU-RSP message in which the information indicating successful authentication as determined by the PLM server is reflected.

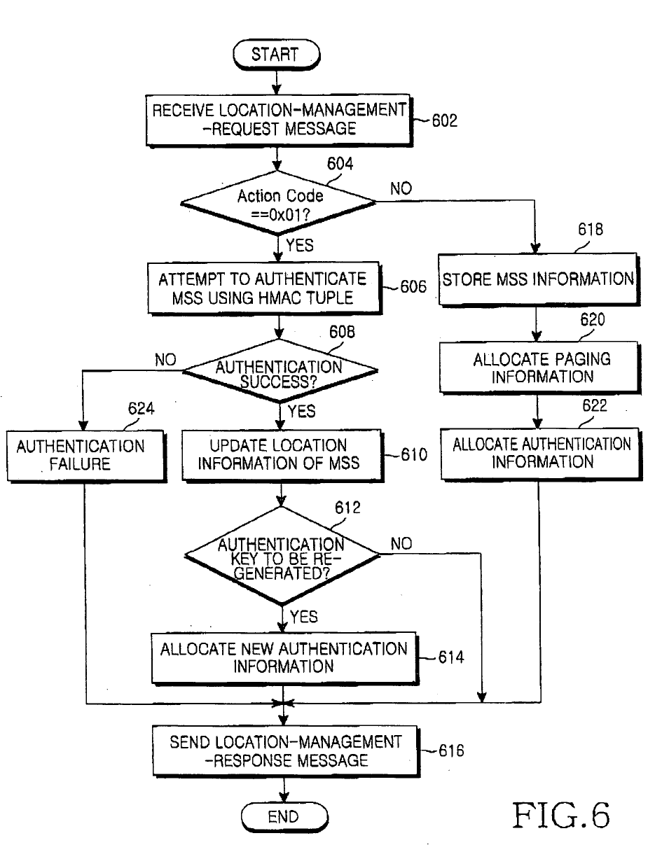

FIG. 6 is a flow chart illustrating a location control operation performed by a PLM server in the IEEE 802.16e communication system in accordance with an embodiment of the present invention.

Referring to FIG. 6, the PLM server receives a LOCATION-MANAGEMENT-REQUEST message from a BS in step 602, and proceeds to step 604. The PLM server determines if an ‘Action Code’ value of the LOCATION-MANAGEMENT-REQUEST message is 0×01 in step 604. If the ‘Action Code’ value is 0×01, the PLM server proceeds to step 606. The PLM server attempts to authenticate the MSS using an HMAC Tuple, and proceeds to step 608. When the PLM server has successfully authenticated the MSS in step 608, it proceeds to step 610. In this case, the PLM server compares a resulting value computed by an authentication algorithm using IDLE_AK used by the MSS with a resulting value computed by an authentication algorithm using IDLE_AK allocated to the MSS by the PLM server. When the two values are identical, it is determined that the MSS is valid. The PLM server updates location information of the MSS in step 610, and proceeds to step 612. The PLM server determines if IDLE_AK must be re-generated after a predetermined time elapses in step 612. If IDLE_AK must be re-generated, the PLM server proceeds to step 614. The PLM server allocates new authentication information for the MSS in step 614, and proceeds to step 616. In step 616, the PLM server sends a LOCATION-MANAGEMENT-RESPONSE message including the authentication information to a corresponding BS in step 616. However, when the PLM server has failed to authenticate the MSS in step 624, it includes authentication failure information in the LOCATION-MANAGEMENT-RESPONSE message and sends the message to a corresponding BS.

However, when the ‘Action Code’ value of the LOCATION-MANAGEMENT-REQUEST message is not 0×01 in step 604, the PLM server proceeds to step 618. The PLM server stores location information of the MSS, and proceeds to step 620. The PLM server allocates paging information (i.e., PAGING_CYCLE, PAGING_OFFSET, and Paging Group ID parameters) for the MSS in step 620, and proceeds to step 622. The PLM server allocates authentication information of the MSS in step 622.

As is apparent from the above description, the present invention allows a mobile subscriber station (MSS) operating in idle mode to safely register location update information, and reduces a range of a paging group by taking into account paging overhead, such that power consumption due to frequent location registration is reduced.

Although preferred embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

1. A method for performing an authentication procedure according to location registration and update for a mobile subscriber station (MSS) in a broadband wireless access (BWA) communication system including the MSS operating in idle mode to minimize power consumption, paging groups each being formed by a plurality of adjacent cells in which a plurality of MSSs are paged, base stations (BSs) for paging the plurality of MSSs within each paging group, and a server for controlling location registration and authentication for the plurality of MSSs, the method comprising:
determining if the server approves a request for transition to the idle mode received from the MSS through a BS;
allocating authentication information from the server to the MSS through the BS if the server approves the request for transition to the idle mode;
registering location of the MSS in the server;
sending a location update request including a resulting value computed using the authentication information allocated from the server when it is determined that the MSS has moved to a different paging group;
authenticating the MSS in the server according to the authentication information included in the location update request; and
registering changed location of the successfully authenticated MSS.

2. The method according to claim 1, wherein determining that the MSS has moved to the different paging group comprises:
receiving paging information periodically broadcast from BSs within a paging group;
comparing last received paging information with previously received paging information; and
determining that the MSS is located in a paging group different from a previous paging group when paging group identification information included in the last received paging information is different from that included in the previously received paging information.

3. The method according to claim 2, wherein authenticating the MSS in the server according to the authentication information included in the location update request comprises:
determining that authentication for the MSS is successful when the resulting value sent from the MSS matches a resulting value computed using an authentication key of the server.

4. The method according to claim 1, wherein the authentication information allocated to the MSS sending the request for the transition to the idle mode includes authentication key information allocated from the server.

5. The method according to claim 1, wherein the authentication information allocated to the MSS includes authentication key information previously allocated from the BS when the MSS performs a network entry procedure.

6. A method for performing an authentication procedure in a mobile subscriber station (MSS) according to location registration and update in a broadband wireless access (BWA) communication system including the MSS operating in idle mode to minimize power consumption, paging groups each being formed by a plurality of adjacent cells in which a plurality of MSSs are paged, base stations (BSs) for paging the plurality of MSSs within each paging group, and a server for controlling location registration and authentication for the plurality of MSSs, the method comprising:
sending, to a first BS, a request for transition to the idle mode when a requirement for transition to the idle mode in which traffic is not generated for a predetermined time is satisfied;
receiving a response to the request for transition to the idle mode;
storing authentication information included in a positive response and performing transition to the idle mode when the response is positive;
periodically broadcasting paging information after transition to the idle mode;
comparing last received paging information with previously received paging information;
determining that a paging group has been changed when paging group identification information included in the last received paging information is different from that included in the previously received paging information;
sending a location update request including a resulting value computed using allocated authentication information; and
receiving, from a second BS, a response to the location update request.

7. The method according to claim 6, further comprising:
performing a ranging procedure with the second BS in the MSS.

8. The method according to claim 6, wherein the authentication information stored in the MSS includes authentication key information allocated from the server.

9. The method according to claim 6, wherein the authentication information stored in the MSS includes authentication key information previously allocated from the first BS when the MSS performs a network entry procedure.

10. A method for performing an authentication procedure in a server according to location registration and update in a broadband wireless access (BWA) communication system including a mobile subscriber station (MSS) operating in idle mode to minimize power consumption, paging groups each being formed by a plurality of adjacent cells in which a plurality of MSSs are paged, base stations (BSs) for paging the plurality of MSSs within each paging group, and the server for controlling location registration and authentication for the plurality of MSSs, the method comprising:
determining if the server approves a request for transition to the idle mode received from the MSS through a first BS;
allocating authentication information to the MSS through the first BS and registering location of the MSS if the server approves the request for transition to the idle mode;
receiving a location update request from a second BS when a paging group for the MSS is changed;
authenticating the MSS; and
sending, to the second BS, a response to the location update request of the MSS according to a result of the authentication.

11. The method according to claim 10, wherein authenticating the MSS comprises:
receiving a first resulting value computed by the MSS using an authentication key of authentication information allocated from the server, the first resulting value being included in the location update request;
computing a second resulting value using an authentication key of authentication information allocated to the MSS in the server; and
successfully authenticating the MSS when the first and second resulting values are identical.

12. A method for performing an authentication procedure according to location change of a mobile subscriber station (MSS) in a broadband wireless access (BWA) communication system including the MSS operating in idle mode, paging groups each being formed by a plurality of adjacent cells in which a plurality of MSSs are paged, base stations (BSs) for paging the plurality of MSSs within each paging group, and a server for controlling location registration and authentication for the plurality of MSSs, the method comprising:
sending a ranging request including authentication information from the MSS to a corresponding BS when the MSS determines that it has moved to the BS of a paging group different from a previous paging group; and
receiving, from the BS, a ranging response indicating if authentication is successful, in the MSS.

13. The method according to claim 12, wherein the authentication information includes an authentication key allocated from the BS when a network entry procedure is performed between the MSS and the BS.

14. The method according to claim 12, wherein the authentication information includes an authentication key allocated from the server.

15. The method according to claim 12, wherein the MSS receives broadcast paging information, and determines that a paging group and a BS for the MSS have been changed when a paging group identifier of the received paging information is different from that of previously received paging information.

16. A system for performing an authentication procedure according to location registration and update in a broadband wireless access (BWA) communication system including a mobile subscriber station (MSS) operating in idle mode to minimize power consumption, paging groups each being formed by a plurality of adjacent cells in which a plurality of MSSs are paged, base stations (BSs) for paging the plurality of MSSs within each paging group, and a server for controlling location registration and authentication for the plurality of MSSs, the system comprising:
the MSS for sending, to a first BS, a request for transition to the idle mode when a requirement for the transition to the idle mode in which traffic is not generated for a predetermined time is satisfied, receiving a response to the request for transition to the idle mode, storing authentication information included in a positive response when the response is positive, and performing transition to the idle mode; and
the server for determining whether to approve the request for transition to the idle mode received from the MSS through the first BS, allocating authentication information to the MSS through the first BS if the request for transition to the idle mode is approved, and registering a location of the MSS.

17. The system according to claim 16, further comprising:
a second BS for periodically broadcasting paging information to a plurality of MSS located within a paging group, performing a ranging procedure with the MSS, sending a location update request according to location registration and update for the MSS, and receiving a response to the request to notify the MSS of the response.

18. The system according to claim 17, wherein the second BS allocates an authentication key when the MSS performs a network entry procedure.

19. The system according to claim 16, wherein when the MSS determines that a paging group for the MSS has been changed, the MSS computes a resulting value using an authentication key of the authentication information allocated from the server, sends a location update request including the resulting value to a second BS, and receives a response to the request.

20. The system according to claim 16, wherein the MSS receives broadcast paging information, and determines that a paging group for the MSS has been changed when a paging group identifier of the received paging information is different from that of previously received paging information.

21. The system according to claim 16, wherein the server compares a resulting value included in a location update request with a resulting value computed using an authentication key of the authentication information allocated to the MSS by the server when receiving the location update request from a second BS according to location change of the MSS, and determines that the MSS has been successfully authenticated when the two values are identical.
